(19) United States
(12) Patent Application Publication
(10) Pub. No.: US 2026/0166812 A1
(43) Pub. Date: Jun. 18, 2026

(54) FLEXIBLE 3D PRINTING MATERIAL WITH DOUBLE-LAYER STRUCTURE AND PREPARATION METHOD

(71) Applicant: Wuyi Sting 3D Technology Co., Ltd., Jinhua (CN)

(72) Inventors: Minfeng Han, Jinhua (CN); Wenjun Fu, Jinhua (CN); Pu Zhang, Jinhua (CN); Xiaojun Zhang, Jinhua (CN); Tao Zhu, Jinhua (CN); Xiaojun Yang, Jinhua (CN)

(21) Appl. No.: 19/407,119

(22) Filed: Dec. 3, 2025

(30) Foreign Application Priority Data
Dec. 12, 2024 (CN) 202411823129.2

(51) Int. Cl. B29C 64/314; B29B 9/08; B29K 75/00; B29K 105/00; B33Y 70/00

(52) U.S. Cl. CPC B29C 64/314; B29B 9/08; B33Y 70/00; B29K 2075/00; B29K 2105/0038; B29K 2995/007

(57) ABSTRACT

A flexible 3D printing material with a double-layer structure and a preparation method thereof are provided. The flexible 3D printing material includes a TPU coating layer and an inner layer TPU composite material. The composition of the TPU coating layer is hard TPU, and the inner layer TPU composite material is composed of the following components: flexible TPU and a coupling agent configured to improve interfacial adhesion strength between components. The inner layer TPU composite material further includes a plasticizer configured to improve the overall elongation at break of a material and reduce its hardness. The plasticizer is one or more of phthalic acid ester, polyethylene Terephthalate, succinate, or dimethyl isophthalic acid ester. The inner flexible material with high elongation at break can be coated with an outer layer material that has moderate hardness, good tensile strength, but low elongation at break.

### CROSS-REFERENCE TO RELATED APPLICATIONS

This application claims priority to Chinese Patent Application No. 202411823129.2, filed on Dec. 12, 2024, which is hereby incorporated by reference in its entirety.

### TECHNICAL FIELD

The present disclosure relates to the field of 3D printing materials technologies, and in particular, to flexible 3D printing material with a double-layer structure and a preparation method thereof.

### BACKGROUND

Fused deposition modeling (FDM) printers have an Automatic Material System, (AMS) automatic material changing system (referred to as AMS in the present disclosure) to achieve automatic color and wire changing functions. This system can fully realize color printing functions for hard plastic 3D printing materials (hardness of 80 D) or above. However, in practical applications, many situations require the use of flexible materials to manufacture products, especially those that require a certain degree of elasticity and bending ability. Although traditional hard materials can meet certain printing needs, their performance is inadequate when manufacturing products that require high flexibility, such as shoe soles, sealing rings, and pipe fittings. Therefore, introducing flexible materials has become an inevitable choice. Flexible materials not only provide the required elasticity and wear resistance but also give printed models a smoother and more delicate surface quality.

The most common 3D printing flexible materials on the market, such as thermoplastic urethanes, (TPU) and thermoplastic elastomer, (TPE), are extruded through a blend molding process. However, this material cannot meet the AMS requirements for 3D printing fused deposition modeling (FDM). During the process of being clamped by gears and dragged by motors in AMS, the material is prone to deformation and jamming, which results in complete failure of automatic material and color changing functions. In response to this issue, CN 2015105942418 provides a new type of hard and flexible 3D printing material. It involves adding some hard materials (such as polyvinyl alcohol, polyvinyl butyral, etc.) that can be softened by post-processing methods and hardening components (such as Polycarbonate, (PC), Acrylonitrile Butadiene Styrene, (ABS), etc.) to the flexible matrix. Firstly, the hard materials are obtained, and then the model made of 3D printed silk is soaked and softened in water, vinegar, alcohol, alkaline solution, or saline solution. This not only solves problems of traditional flexible material printing but also achieves required flexibility of the material in application. Besides that, because this flexible material is in a hard state before printing and has good mechanical properties, it can smoothly pass through a gear transmission system of the AMS without getting stuck, which means it can adapt well to application scenarios that require frequent material replacement.

However, using this method to produce flexible products involves a complex process and greatly increases production costs. Moreover, if the problem of flexible materials getting stuck in AMS is only solved by increasing the hardness, the flexibility and elasticity of the printed flexible products will deteriorate. In existing research, it has been further found that if the material has a high elongation at break, during the material retreat process, if there is a large resistance, the material will still undergo deformation. The stretching length will cause the material diameter to become thinner and ineffective in meshing. This deformation will cause the material to get stuck in the gear, which is the main reason why flexible materials get stuck in AMS transmission gears. Therefore, it is feasible to develop a flexible material that can be used for AMS but can directly print flexible products by simultaneously regulating the hardness and elongation at break of the material.

### SUMMARY

The present disclosure proposes a flexible 3D printing material with a double-layer structure and a preparation method thereof. By coating an inner flexible material with a moderately hard and high tensile strength but low elongation at break, the 3D printing material can be smoothly replaced in AMS and flexible products can be printed using FDM without additional processing.

In order to solve the above technical problems, the technical solution of the present disclosure is as follows.

A flexible 3D printing material with a double-layer structure, including: a TPU coating layer and an inner layer TPU composite material; the TPU coating layer is composed of hard TPU, and the inner layer TPU composite material is composed of the following components: a flexible TPU and a coupling agent configured to improve interfacial adhesion strength between components; where the inner layer TPU composite material further includes a plasticizer, and the plasticizer is configured to improve an overall elongation at break of a material and reduce a hardness; the plasticizer is one or more of phthalic acid ester, polyethylene Terephthalate, succinate, or dimethyl isophthalic acid ester.

The present disclosure uses the hard TPU coating on an outside of the flexible TPU, so that the 3D printing material is in a state of moderate hardness, good tensile strength, and low elongation at break under normal conditions, thereby achieving smooth wire replacement of the 3D printing material located in AMS. When the 3D printing material is placed inside a print head of a FDM and subjected to secondary heating, the inner layer material will mix with the outer layer material and react, changing the overall properties of the material, reducing its hardness, and increasing its elongation at break, thereby achieving the printing of flexible products.

In some embodiments of the present disclosure, the TPU coating layer will use hard TPU with moderate hardness, good tensile strength, and low elongation at break, and the flexible TPU in the inner TPU composite material is a common flexible material. The plasticizer added to the inner TPU composite material can make the material softer during the secondary heating and melting process of FDM, reduce the overall hardness of the material, and increase the elongation at break, achieving the transformation of hard materials into flexible materials. The reason for this change is that plasticizer molecules are usually small and can be inserted between polymer chains (TPU), breaking the original intermolecular forces and reducing the glass transition temperature of the material, making it easier to deform without fracture; and when plasticizer molecules are inserted between polymer chains, they reduce the friction between polymer chains, rendering it easier for the segments to slide, thereby improving the ductility and elongation at break of the material.

Where phthalic acid ester, polyethylene Terephthalate, and dimethyl isophthalic acid ester: these plasticizers have aromatic ring structures and can form hydrogen bonds with polar groups (such as urea or amino ester groups) in TPU through ester groups, thereby improving compatibility with TPU. The succinate has a longer alkyl chain, which helps to improve the flexibility of the material, and its ester group can also interact with the polar groups in TPU, thereby further enhancing compatibility. Therefore, one or more of these four substances were selected as the plasticizer.

In some embodiments of the present disclosure, it is made of the following components by mass of parts: Hard TPU: 90-100 parts, flexible TPU: 30-70 parts, coupling agent: 1.5-3 parts, plasticizer: 0.5-2 parts.

The additional amount of the hard TPU in the coating layer is relatively high, which can ensure that the overall hardness and tensile strength of the material are in a moderate state, allowing the double-layer structural material to be smoothly transferred and replaced in the AMS system. The addition of flexible TPU is to endow the material with sufficient flexibility and elasticity during the FMD printing process, enabling it to print soft products. The addition of the coupling agent is to improve the interfacial bonding strength between the hard TPU and the flexible TPU, ensuring a tight bond between the two layers of materials in a non-molten state and preventing delamination.

In some embodiments of the present disclosure, the coupling agent is γ-aminopropyltriethoxysilane. γ-aminopropyltriethoxysilane molecules contain two different active groups—aminopropyl and silane groups. The aminopropyl can form hydrogen bonds with polar groups (such as urea or carbamate groups) in TPU, thereby improving the interfacial bonding strength between the hard TPU and the flexible TPU in TPU composite materials. At the same time, silane groups can react with hydroxyl groups on the surfaces of inorganic and organic materials to form stable silicon oxygen bonds, thereby enhancing interfacial adhesion. In summary, under the combined action of hydrogen bonding and silicon oxygen bonding, the internal connections of the bilayer structure are firmer, thereby avoiding delamination and peeling phenomena. It is worth noting that the amino propyl and ethoxy groups have good compatibility with the polymer chain of TPU, which enables the coupling agent to effectively disperse in the TPU matrix. The improvement of compatibility also makes it easier for plasticizer molecules to enter between TPU chains, resulting in a more uniform distribution of changes in the overall hardness and elongation at break of the material during the printing process.

In some embodiments of the present disclosure, a hardness of the hard TPU is 70-75 D, and a hardness of the flexible TPU is 85-95 A. As the coating layer, the hard TPU needs to have good hardness and tensile strength. TPU with a hardness of 70-75 D also has relatively good tensile strength, which allows the 3D printing material to smoothly pass through the AMS motor clamping and transmission tension dragging, thereby achieving free color change function in AMS. But the hardness of hard TPU cannot be too high. If the hardness is too high, TPU will become very hard, difficult to bend, and easy to break. During the wire changing process, the material may get stuck or cause pipeline blockage during transmission, and if the hardness is too low, it will become a common flexible material and cannot be used in AMS. Similarly, the hardness of the flexible TPU cannot be too low, as it can cause the final printed product to become too soft and prone to collapse during the printing process.

In some embodiments of the present disclosure, the inner TPU composite material further includes 0.1 to 5 parts of a foaming agent, the foaming agent is an azo compound. The foaming agent will play a role in the printing process (i.e. the secondary heating and melting process of FDM), causing bubbles to exist inside the printed material. The bubbles form a porous structure inside the material, and this structure can absorb external forces and allow the material to undergo more deformation when stretched. Therefore, when the foam material is stretched, the bubbles can deform and compress, thereby increasing the elongation at break of the printed material. Moreover, the presence of bubbles can disperse the stress applied to the material. When the material is stretched, the stress will not concentrate at a certain point, but will be distributed at the interface between the bubbles and the matrix. This reduces the possibility of material fracture, rendering the printed flexible product flexible and elastic.

It is worth mentioning that if the temperature at which the foaming agent reacts is low, it is highly likely that a foaming reaction occurs during a manufacturing stage of the flexible 3D printing material with a double-layer structure, which will result in uneven distribution of pores within the material, making it difficult for the foaming agent to function again during FDM printing in the future. The size of the printed materials produced simultaneously is also difficult to control. Therefore, in the present disclosure, the azo compound with high thermal stability and the ability to maintain stability at high temperatures until reaching the decomposition temperature are selected as the foaming agent in this formula. This characteristic allows the foaming agent to only function during the secondary heating and melting process of FDM. In this way, it effectively avoids the reaction of the foaming agent during the material manufacturing stage.

Where the inner TPU composite material further includes 5-10 parts talc powder. The talc powder can improve the flowability of the TPU composite material in a molten state, making them easier to pass through extruders or print heads and increasing processing efficiency. It is worth mentioning that after adding talc powder, it will be distributed in the pore structure and matrix, which can improve the stability of the pores of the foamed material, preventing the collapse or deformation of the pores during the cooling process. This is crucial for the dimensional accuracy, surface smoothness, and overall structural integrity of the 3D printed products, ensuring that the printed parts still maintain good dimensional stability and mechanical properties after cooling.

In some embodiments of the present disclosure, both the TPU coating layer and the inner TPU composite material further include 1-10 parts of Ethylene Copolymer, SOG compatibilizer, and the SOG compatibilizer is a polymer formed by grafting glycidyl methacrylate, (GMA) onto a main chain of ethylene-based elastomers. Adding the SOG compatibilizer to the inner and outer layer materials can further promote the uniform dispersion of each component and improve the interfacial bonding strength between materials. This is because the GMA part contains polar epoxy groups, which can interact with polar groups (such as amino ester groups or ester groups) in TPU through hydrogen bonding or covalent bonding. This interaction enhances the compatibility between GMA graft polymer and TPU matrix. The polyolefin main chain of the SOG compatibilizer is non-polar, and there is van der Waals force between it and non-polar fillers such as talc powder. This weaker physical force helps to disperse the filler in the polymer matrix. In this way, GMA grafted polymers act as a bridge, with one end connected to the TPU matrix through its polar GMA portion, and the other end interacting with non-polar fillers through its non-polar polyolefin backbone. This bridging effect effectively connects two materials of different polarities together, reducing interfacial tension and improving the overall compatibility of the composite material.

The present disclosure further provides a preparation method for a flexible 3D printing material with a double-layer structure, including the following steps:
S1: separating a TPU coating layer and an inner TPU composite material into particles using a plastic granulator;
S2: using a dual extrusion structure and a single-mode mouth forming processing technology, TPU coating particles and inner TPU composite material particles being separately placed into two single screw extruders;
S3: setting screw rotation speeds and processing temperatures of the two single screw extruders, starting the screw extruders, and allowing melted TPU coating layer and melted inner TPU composite material to flow into corresponding channels of a single-mode mold; subsequently, in a fusion zone of the mold, melted TPU coating layer uniformly covering an outer layer of the melted inner TPU composite material, and extruding together at an exit of the mold to form a double-layer structure material;
S4: cooling and shaping the flexible 3D printing material with a double-layer structure.

In this way, the flexible 3D printing material of the double-layer structure of the present disclosure can be manufactured. Through the method of step S3, the hard TPU can effectively encapsulate the flexible TPU, thereby forming a double-layer flexible material with high surface hardness, high tensile strength, low internal hardness, and softness. The coupling agent can better bond the inner and outer layers of TPU, thereby avoiding delamination and peeling.

In some embodiments of the present disclosure, in step S3, a highest temperature in a single screw machine for extruding the TPU coating layer does not exceed 215° C., and a highest temperature in a single screw machine for extruding the inner layer TPU composite material does not exceed 190° C. Due to the poor flowability of TPU material at lower temperatures, it is necessary to maintain a relatively high temperature inside the single screw machine. However, degradation is prone to occur at excessively high temperatures, leading to a decrease in material performance. Therefore, by setting the maximum temperature for extruding TPU coating layer not to exceed 215° C., it can ensure that the material has good fluidity in the molten state without degradation. Moreover, within this temperature range, the viscosity of the TPU coating layer will decrease, making it easier to coat the inner layer material. For the inner layer TPU composite material, the extrusion temperature should not be too high, as too high temperature can cause the foaming agent to react prematurely, and too low a temperature can also lead to poor flowability, affecting the coating process of the inner and outer layers of TPU. It should be noted that if the temperature of the extruded TPU coating layer is too high, the high temperature will be transmitted to the inner TPU composite material, which will also cause the foaming agent to react prematurely. Therefore, in order to ensure that the foaming agent only plays a role in the FDM printing process, the maximum temperature of the extruded TPU coating layer should not exceed 215° C.

In some embodiments of the present disclosure, in step S3, a screw rotation speed of the single screw machine for extruding the TPU coating layer is 400-500 r/min, and a screw rotation speed of the single screw machine for extruding the inner layer TPU composite material is 30-50 r/min. A higher screw speed provides better fluidity, which helps to evenly distribute the hard TPU in the mold and avoid uneven coating caused by insufficient fluidity. A lower screw speed helps to fully mix the various components in the inner TPU composite material (such as flexible TPU, coupling agent, plasticizer, etc.) before extrusion, ensuring the uniformity and stability of the material. However, excessive rotational speed may cause TPU materials to experience excessive shear forces during extrusion, leading to thermal degradation of the material and affecting its mechanical properties and durability. Slow rotation speed can lead to insufficient fluidity of the TPU coating layer, which may prevent smooth extrusion and cause material blockage in the extruder. For the inner TPU composite materials, low speed may cause uneven mixing of the coupling agent, plasticizer, and other additives, thereby affecting the performance of the material.

In summary, such a flexible 3D printing material with a double-layer structure and its preparation method, by coating the inner layer of flexible material with high elongation at break by an outer layer material with moderate hardness and good tensile strength but low elongation at break, allows the 3D printing material to be smoothly replaced in AMS and flexible products to be printed using FDM without additional processing.

### DESCRIPTION OF EMBODIMENTS

It should be noted that the description of these embodiments is intended to assist in understanding the present disclosure, but does not constitute a limitation of the present disclosure. Besides that, the technical features involved in the various embodiments of the present disclosure described below can be combined with each other as long as they do not conflict with each other.

A flexible 3D printing material with a double-layer structure, including: a TPU coating layer and an inner layer TPU composite material; the TPU coating layer is composed of hard TPU, and the inner layer TPU composite material is composed of the following components: a flexible TPU and a coupling agent configured to improve interfacial adhesion strength between components; where the inner layer TPU composite material further includes a plasticizer, and the plasticizer is configured to improve an overall elongation at break of a material and reduce a hardness; the plasticizer is one or more of phthalic acid ester, polyethylene Terephthalate, succinate, or dimethyl isophthalic acid ester.

The present disclosure uses the hard TPU coating on an outside of the flexible TPU, so that the 3D printing material is in a state of moderate hardness, good tensile strength, and low elongation at break under normal conditions, thereby achieving smooth wire replacement of the 3D printing material located in AMS. When the 3D printing material is placed inside a print head of a FDM and subjected to secondary heating, the inner layer material will mix with the outer layer material and react, changing the overall properties of the material, reducing its hardness, and increasing its elongation at break, thereby achieving the printing of flexible products.

In an implementation mode, the TPU coating layer will use hard TPU with moderate hardness, good tensile strength, and low elongation at break, and the flexible TPU in the inner TPU composite material is a common flexible material. The plasticizer added to the inner TPU composite material can make the material softer during the secondary heating and melting process of FDM, reduce the overall hardness of the material, and increase the elongation at break, achieving the transformation of hard materials into flexible materials. The reason for this change is that plasticizer molecules are usually small and can be inserted between polymer chains (TPU), breaking the original intermolecular forces and reducing the glass transition temperature of the material, making it easier to deform without fracture; and when plasticizer molecules are inserted between polymer chains, they reduce the friction between polymer chains, making it easier for the segments to slide, thereby improving the ductility and elongation at break of the material.

Where phthalic acid ester, polyethylene Terephthalate, and dimethyl isophthalic acid ester: these plasticizers have aromatic ring structures and can form hydrogen bonds with polar groups (such as urea or amino ester groups) in TPU through ester groups, thereby improving compatibility with TPU. The succinate has a longer alkyl chain, which helps to improve the flexibility of the material, and its ester group can also interact with the polar groups in TPU, further enhancing compatibility. Therefore, one or more of these four substances were selected as the plasticizer.

In an implementation mode, it is made of the following components by mass of parts: Hard TPU: 90-100 parts, flexible TPU: 30-70 parts, coupling agent: 1.5-3 parts, plasticizer: 0.5-2 parts.

The additional amount of hard TPU in the coating layer is relatively high, which can ensure that the overall hardness and tensile strength of the material are in a moderate state, allowing the double-layer structural material to be smoothly transferred and replaced in the AMS system. The addition of flexible TPU is to endow the material with sufficient flexibility and elasticity during the FMD printing process, enabling it to print soft products. The addition of the coupling agent is to improve the interfacial bonding strength between the hard TPU and the flexible TPU, ensuring a tight bond between the two layers of materials in a non-molten state and preventing delamination.

In an implementation mode, the coupling agent is γ-aminopropyltriethoxysilane. γ-aminopropyltriethoxysilane molecules contain two different active groups—aminopropyl and silane groups. The aminopropyl can form hydrogen bonds with polar groups (such as urea or carbamate groups) in TPU, thereby improving the interfacial bonding strength between the hard TPU and the flexible TPU in TPU composite materials. At the same time, silane groups can react with hydroxyl groups on the surfaces of inorganic and organic materials to form stable silicon oxygen bonds, thereby enhancing interfacial adhesion. In summary, under the combined action of hydrogen bonding and silicon oxygen bonding, the internal connections of the bilayer structure are firmer, avoiding delamination and peeling phenomena.

It is worth noting that the amino propyl and ethoxy groups have good compatibility with the polymer chain of TPU, which enables the coupling agent to effectively disperse in the TPU matrix. The improvement of compatibility also makes it easier for plasticizer molecules to enter between TPU chains, resulting in a more uniform distribution of changes in the overall hardness and elongation at break of the material during the printing process.

In an implementation mode, a hardness of the hard TPU is 70-75 D, and a hardness of the flexible TPU is 85-95 A. As the coating layer, the hard TPU needs to have good hardness and tensile strength. TPU with a hardness of 70-75 D also has relatively good tensile strength, which allows the 3D printing material to smoothly pass through the AMS motor clamping and transmission tension dragging, thereby achieving free color change function in AMS. But the hardness of hard TPU cannot be too high. If the hardness is too high, TPU will become very hard, difficult to bend, and easy to break. During the wire changing process, the material may get stuck or cause pipeline blockage during transmission, and if the hardness is too low, it will become a common flexible material and cannot be used in AMS. Similarly, the hardness of the flexible TPU cannot be too low, as it can cause the final printed product to become too soft and prone to collapse during the printing process.

In an implementation mode, the inner TPU composite material further includes 0.1 to 5 parts of a foaming agent, the foaming agent is an azo compound. The foaming agent will play a role in the printing process (i.e. the secondary heating and melting process of FDM), causing bubbles to exist inside the printed material. The bubbles form a porous structure inside the material; this structure can absorb external forces and allow the material to undergo more deformation when stretched. Therefore, when the foam material is stretched, the bubbles can deform and compress, thereby increasing the elongation at break of the printed material. Moreover, the presence of bubbles can disperse the stress applied to the material. When the material is stretched, the stress will not concentrate at a certain point but will be distributed at the interface between the bubbles and the matrix. This reduces the possibility of material fracture, rendering the printed flexible product flexible and elastic.

It is worth mentioning that if the temperature at which the foaming agent reacts is low, it is highly likely that a foaming reaction occurs during a manufacturing stage of the flexible 3D printing material with a double-layer structure, which will result in uneven distribution of pores within the material, making it difficult for the foaming agent to function again during FDM printing in the future. The size of the printed materials produced simultaneously is also difficult to control. Therefore, in the present disclosure, the azo compound with high thermal stability and the ability to maintain stability at high temperatures until reaching the decomposition temperature are selected as the foaming agent in this formula. This characteristic allows the foaming agent to only function during the secondary heating and melting process of FDM. In this way, it effectively avoids the reaction of foaming agents during the material manufacturing stage.

Where the inner TPU composite material further includes 5-10 parts of talc powder. Talc powder can improve the flowability of TPU composite materials in a molten state, rendering them easier to pass through an extruder or a print head and increasing processing efficiency.

It is worth mentioning that after adding talc powder, it will be distributed in the pore structure and matrix, which can improve the stability of the pores of the foamed material, preventing the collapse or deformation of the pores during the cooling process. This is crucial for the dimensional accuracy, surface smoothness, and overall structural integrity of the 3D printed products, ensuring that the printed parts still maintain good dimensional stability and mechanical properties after cooling.

In an implementation mode, both the TPU coating layer and the inner TPU composite material further include 1-10 parts of SOG compatibilizer, and the SOG compatibilizer is a polymer formed by grafting glycidyl methacrylate, (GMA) onto a main chain of ethylene-based elastomers. Adding the SOG compatibilizer to the inner and outer layer materials can further promote the uniform dispersion of each component and improve the interfacial bonding strength between materials. This is because the GMA part contains polar epoxy groups, which can interact with polar groups (such as amino ester groups or ester groups) in TPU through hydrogen bonding or covalent bonding. This interaction enhances the compatibility between GMA graft polymer and TPU matrix. The polyolefin main chain of the SOG compatibilizer is non-polar, and there is van der Waals force between it and non-polar fillers such as talc powder. This weaker physical force helps to disperse the filler in the polymer matrix. In this way, GMA grafted polymers act as a bridge, with one end connected to the TPU matrix through its polar GMA portion, and the other end interacting with non-polar fillers through its non-polar polyolefin backbone. This bridging effect effectively connects two materials of different polarities together, reducing interfacial tension and improving the overall compatibility of the composite material.

The present disclosure further provides a preparation method for a flexible 3D printing material with a double-layer structure, including the following steps:
S1: separating a TPU coating layer and an inner TPU composite material into particles using a plastic granulator;
S2: using a dual extrusion structure and a single-mode mouth forming processing technology, TPU coating particles and inner TPU composite material particles being separately placed into two single screw extruders;
S3: setting screw rotation speeds and processing temperatures of the two single screw extruders, starting the screw extruders, and allowing melted TPU coating layer and melted inner TPU composite material to flow into corresponding channels of a single-mode mold; subsequently, in a fusion zone of the mold, melted TPU coating layer uniformly covering an outer layer of the melted inner TPU composite material, and extruding together at an exit of the mold to form a double-layer structure material;
S4: cooling and shaping the flexible 3D printing material with a double-layer structure.

In this way, the flexible 3D printing material of the double-layer structure of the present disclosure can be manufactured. Through the method of step S3, the hard TPU can effectively encapsulate the flexible TPU, thereby forming a double-layer flexible material with high surface hardness, high tensile strength, low internal hardness, and softness. The coupling agent can better bond the inner and outer layers of TPU, thereby avoiding delamination and peeling.

In an implementation mode, in step S3, a highest temperature in a single screw machine for extruding the TPU coating layer does not exceed 215° C., and a highest temperature in a single screw machine for extruding the inner layer TPU composite material does not exceed 190° C. Due to the poor flowability of TPU material at lower temperatures, it is necessary to maintain a relatively high temperature inside the single screw machine. However, degradation is prone to occur at excessively high temperatures, leading to a decrease in material performance. Therefore, by setting the maximum temperature for extruding TPU coating layer not to exceed 215° C., it can ensure that the material has good fluidity in the molten state without degradation. Moreover, within this temperature range, the viscosity of the TPU coating layer will decrease, making it easier to coat the inner layer material. For the inner layer TPU composite material, the extrusion temperature should not be too high, as too high temperature can cause the foaming agent to react prematurely, and too low temperature can also lead to poor flowability, affecting the coating process of the inner and outer layers of TPU.

It should be noted that if the temperature of the extruded TPU coating layer is too high, the high temperature will be transmitted to the inner TPU composite material, which will also cause the foaming agent to react prematurely. Therefore, to ensure that the foaming agent only plays a role in the FDM printing process, the maximum temperature of the extruded TPU coating layer should not exceed 215° C.

In an implementation mode, in step S3, a screw rotation speed of the single screw machine for extruding the TPU coating layer is 400-500 r/min, and a screw rotation speed of the single screw machine for extruding the inner layer TPU composite material is 30-50 r/min. A higher screw speed provides better fluidity, which helps to evenly distribute the hard TPU in the mold and avoid uneven coating caused by insufficient fluidity. A lower screw speed helps to fully mix the various components in the inner TPU composite material (such as flexible TPU, coupling agent, plasticizer, etc.) before extrusion, ensuring the uniformity and stability of the material. However, excessive rotational speed may cause the TPU material to experience excessive shear forces during extrusion, leading to thermal degradation of the material and affecting its mechanical properties and durability. Slow rotation speed can lead to insufficient fluidity of the TPU coating layer, which may prevent smooth extrusion and cause material blockage in the extruder. For the inner TPU composite materials, low speed may cause uneven mixing of coupling agents, plasticizers, and other additives, affecting the performance of the material.

In summary, such a flexible 3D printing material with a double-layer structure and its preparation method, by coating the inner layer of flexible material with high elongation at break by an outer layer material with moderate hardness and good tensile strength but low elongation at break, allows the 3D printing material to be smoothly replaced in AMS and flexible products to be printed using FDM without additional processing.

To verify the effectiveness, AMS equipment printed using FDM was tested.

Example 1: Hard TPU: 90 parts, flexible TPU: 50 parts, polyethylene Terephthalate: 0.5 parts, succinate: 0.5 parts, γ-Aminopropyltriethoxysilane: 1.5 parts, azo compound: 1 part, talc powder: 5 parts, SOG compatibilizer: 3 parts. The hardness of hard TPU is 70 D, and the hardness of flexible TPU is 95 A. The above materials were prepared into 1.75 mm straight thread. The highest temperature in the single screw machine for extruding the TPU coating layer was 215° C., and the screw rotation speed was 400 r/min. The highest temperature in the single screw machine for extruding the inner layer TPU composite material was 180° C., and the screw rotation speed of the single screw machine was 30 r/min.

The processed 1.75 mm straight warp wire has a length of 1000 mm, under a tensile force of 12 Nd, the material elongates by 108 mm, with an elongation rate of 8%. After standard processing and testing of 3D printed splines, the tensile strength of the material is 28 Mpa-29 Mpa, the elongation at break is 410-430%, and the hardness test is 51-52D. The printed product has good flexibility.

Example 2: Hard TPU: 95 parts, flexible TPU: 60 parts, phthalic acid ester: 0.1 parts, polyethylene Terephthalate: 0.3 parts, succinate: 0.2 parts, γ-aminopropyltriethoxysilane: 2 parts, azo compound: 2 parts, talc powder: 5 parts, SOG compatibilizer: 3 parts. The hardness of the hard TPU is 70 D, and the hardness of the flexible TPU is 95 A. The above materials were prepared into 1.75 mm straight thread. The highest temperature in the single screw machine for extruding the TPU coating layer was 215° C., and the screw rotation speed was 400 r/min. The highest temperature in the single screw machine for extruding the inner layer TPU composite material was 185° C., and the screw rotation speed of the single screw machine was 45 r/min.

The processed 1.75 mm straight warp wire has a length of 1000 mm, under a tensile force of 12 N, the material elongates by 106 mm, with an elongation rate of 6%. After standard processing and testing of 3D printed splines, and tensile strength of the material is 30-32 Mpa, the elongation at break is 430-460%, and the hardness test is 50-52 D. The printed product has good flexibility.

Comparative Example: Compared to Example 2, only the treatment without adding phthalic acid ester, polyethylene Terephthalate, succinate was performed.

The processed 1.75 mm straight warp wire has a length of 1000 mm, under a tensile force of 12 N, the material elongates by 103 mm, with an elongation rate of 3%. After standard processing and testing of 3D printed splines, the tensile strength of the material is 43-44 Mpa, the elongation at break is 250-300%, and the hardness test is 60-62 D. The printed product has lost the flexibility it should have.

According to the above technical solution, tests were conducted on AMS equipment for FDM printing.

Example 1: AMS successfully passed the test, preferably with no obstacles after more than 1000 color and material changes; capable of smoothly printing flexible products in different colors.

Example 2: AMS successfully passed the test, preferably with no obstacles after more than 1000 color and material changes; capable of smoothly printing flexible products in different colors.

Comparison Example: in AMS, the material showed significant lagging in the transmission pipeline; the printed product does not meet the requirements of flexible products and has poor flexibility.

From the above, it can be seen that the technical features of the present disclosure can achieve material replacement in AMS systems and smoothly print flexible products of different colors. The rational use of plasticizers plays a key role. Not adding plasticizers can cause the material to lose some flexibility and may get stuck in the transmission channel during the dragging process of AMS motor clamping and transmission tension.

For those skilled in the art, various changes, modifications, substitutions, and variations of these embodiments without departing from the principles and spirit of the present disclosure still fall within the protection scope of the present disclosure.

What is claimed is:

1. A flexible 3D printing material with a double-layer structure, comprising: a TPU coating layer and an inner layer TPU composite material;
the TPU coating layer is composed of hard TPU, and the inner layer TPU composite material is composed of the following components: a flexible TPU and a coupling agent configured to improve interfacial adhesion strength between components;
wherein the inner layer TPU composite material further comprises a plasticizer, and the plasticizer is configured to improve an overall elongation at break of a material and reduce a hardness;
the plasticizer is one or more of phthalic acid ester, polyethylene Terephthalate, succinate, or dimethyl isophthalic acid ester;
wherein the flexible 3D printing material is made of the following components by mass of parts: Hard TPU: 90-100 parts, flexible TPU: 30-70 parts, coupling agent: 1.5-3 parts, plasticizer: 0.5-2 parts;
wherein the coupling agent is γ-aminopropyltriethoxysilane;
wherein a hardness of the hard TPU is 70-75 D, and a hardness of the flexible TPU is 85-95 A.

2. The flexible 3D printing material with a double-layer structure according to claim 1, wherein the inner layer TPU composite material further comprises 0.1-5 parts of a foaming agent, and the foaming agent is an azo compound.

3. The flexible 3D printing material with a double-layer structure according to claim 2, wherein the inner layer TPU composite material further comprises 5-10 parts talc powder.

4. The flexible 3D printing material with a double-layer structure according to claim 3, wherein both the TPU coating layer and the inner TPU composite material further comprise 1-10 parts of SOG compatibilizer, and the SOG compatibilizer is a polymer formed by grafting glycidyl methacrylate, (GMA) onto a main chain of ethylene-based elastomer.

5. A preparation method for a flexible 3D printing material with a double-layer structure, wherein the preparation method is configured to prepare the flexible 3D printing material with a double-layer structure according to claim 1, and the preparation method comprises the following steps:
S1: separating a TPU coating layer and an inner TPU composite material into particles using a plastic granulator;
S2: using a dual extrusion structure and a single-mode mouth forming processing technology, TPU coating particles and inner TPU composite material particles being separately placed into two single screw extruders;
S3: setting screw rotation speeds and processing temperatures of the two single screw extruders, starting the screw extruders, and allowing melted TPU coating layer and melted inner TPU composite material to flow into corresponding channels of a single-mode mold; subsequently, in a fusion zone of the mold, melted TPU coating layer uniformly covering an outer layer of the melted inner TPU composite material, and extruding together at an exit of the mold to form a double-layer structure material;
S4: cooling and shaping the flexible 3D printing material with a double-layer structure.

6. The preparation method for a flexible 3D printing material with a double-layer structure according to claim 5, wherein in step S3, a highest temperature in a single screw machine for extruding the TPU coating layer does not exceed 215° C., and a highest temperature in a single screw machine for extruding the inner layer TPU composite material does not exceed 190° C.

7. The preparation method for a flexible 3D printing material with a double-layer structure according to claim 6, wherein in step S3, a screw rotation speed of the single screw machine for extruding the TPU coating layer is 400-500 r/min, and a screw rotation speed of the single screw machine for extruding the inner layer TPU composite material is 30-50 r/min.
